(19) United States
(12) Patent Application Publication
(10) Pub. No.: US 2010/0264580 A1
(43) Pub. Date: Oct. 21, 2010

(54) DRIVE FOR BANKNOTE CENTERING MECHANISM

(75) Inventors: Leon Saltsov, Thornhill (CA); Oleksandr Onipchenko, Thornhill (CA); Oleksandr Soyfer, North York (CA)

Correspondence Address: DENNISON ASSOCIATES, 133 RICHMOND STREET WEST, SUITE 301, TORONTO, ON, M5H 2L7, CA

(73) Assignees: CASHCODE COMPANY INC., CONCORD, ON (CA); CRANE CANADA CO., CONCORD, ON (CA)

(21) Appl. No.: 12/451,254

(22) PCT Filed: May 5, 2008
(86) PCT No.: PCT/CA2008/000855

§ 371 Date: Jun. 17, 2010

(30) Foreign Application Priority Data
May 3, 2007 (CA) 2,587,168

(51) Int. Cl. B65H 9/10; F16H 19/04

(52) U.S. Cl. 271/240; 74/29

(57) ABSTRACT

An improved drive arrangement for side engaging members of a banknote centering mechanism uses a rack and pinion combination. A low torque motor drives a spur gear that engages opposed rack gears of the side engaging members. This power transfer from the motor to the side engaging member is cost effective and provides good precision.

### FIELD OF THE INVENTION

The present application is directed to a banknote centering mechanism and in particular, to an improved drive arrangement for the banknote centering mechanism.

### BACKGROUND OF THE INVENTION

Our earlier U.S. Pat. No. 6,149,150 discloses a banknote centering mechanism having a banknote slot of a size for receiving banknotes of different widths and allowing the banknotes to pass through the slot to a banknote centering mechanism. The banknote centering mechanism has a pair of opposed side engaging members which are movable towards one another and allow centering of the banknote between the two side members. The drive arrangement for moving the banknote from the banknote slot to the centering mechanism effectively releases the banknote within the centering mechanism allowing the banknote to float and thereafter be centered by the side engaging members.

The side engaging members are driven by a common drive arrangement which moves the side engaging members together until such time as the banknote is centered and effectively opposes further inward movement of the side engaging members. This creates a stall condition and thus banknotes of different widths can be effectively centered.

Also disclosed in our earlier patent is the use of a worm drive arrangement for moving of the side members towards one another, as well as a particular sequence for assessing the amount of power necessary for centering a banknote effectively. This sequence includes cycling of the side members towards one another to access changing frictional forces which may occur in the banknote centering mechanism from time to time. With this measure as a base, the additional power for centering is set.

### SUMMARY OF THE INVENTION

The present invention provides an improved drive arrangement for the side engaging members of the centering mechanism where the drive arrangement includes a rack and pinion power transfer mechanism for controlling the position of the side engaging members. This drive arrangement provides an effective power transfer mechanism and provides improved control of the side engaging members. Improved precision in setting the power for centering or assessing the stall condition is realized as there is less variation in the power transfer due to the rack and pinion drive arrangement.

### BRIEF DESCRIPTION OF THE DRAWINGS

Preferred embodiments of the invention are shown in the drawings, wherein:

FIG. 1 is a top view showing the two side engaging members and a rack and pinion drive arrangement;

FIG. 2 is a sectional view of the rack and pinion drive arrangement for the side engaging members taking along line A-A; and

FIG. 3 is a sectional view taking along line B-B of FIG. 1.

FIG. 4 is a partial perspective view of an alternative banknote centering arrangement;

FIG. 5 is a bottom perspective view of the alternate arrangement shown in FIG. 4;

FIG. 6 is a top view of the alternate arrangement shown in FIG. 4;

FIG. 7 is a sectional view taken along line AA shown in FIG. 6;

FIG. 8 is a sectional view taken along line B-B shown in FIG. 6;

FIG. 9 is a perspective of a banknote validator and centering mechanism and a banknote cassette; and

FIG. 10 is a sectional view through a validator head having a banknote centering mechanism.

### DETAILED DESCRIPTION OF THE PREFERRED EMBODIMENTS

As shown in our earlier patent, a banknote centering mechanism is provided in front of a banknote validator to effectively center the banknote for processing by the validator. The banknote centering mechanism provides advantages with respect to the validator, particularly in countries or regions where the currency provided to the device is of different widths. By effectively centering each banknote prior to processing by the validator, the evaluation of the authenticity of the banknote is greatly simplified. Furthermore, precision in locating of the center line of the banknote also allows improvements in the processing of the data and/or reduced processing time.

The banknote centering mechanism 2 includes opposed side members 4 and 6 which move towards one another in a controlled manner determined by the centering banknote drive 8. Each of the side members 4 and 6 includes a rack gear 14 and 16 respectively which cooperates with the spur gear 12 of the centering banknote drive 8. The spur gear 12 is driven by the motor 10.

Each of the opposed side members 4 and 6 are slidable along guide shafts 21 and 23 to allow the movement of the side engaging members towards or away from one another, controlled by the centering banknote drive 8. This banknote centering mechanism works in a similar manner to our earlier U.S. Pat. No. 6,149,150 with the centering banknote drive 8 replacing the former worm gear drive. Various shaft arrangements for controlling sliding of the side members can be used. It has been found that the spur gear and rack drive arrangement provides excellent control and movement of the side engaging members towards one another. This allows accurate coordination of the stall condition with the buckling force provided by a banknote as it is centered by the side engaging members. Also this drive arrangement is quite cost effective. The spur gear and rack drive arrangement tends to have less variation and lower friction over time relative to our earlier worm drive arrangement. The worm drive arrangement can develop a high static torque necessary to initially move the side members 4 and 6. Dirt, wear and other contaminates can cause significant variations making it more difficult to adjust over time. The rack and pinion drive is more tolerant.

In a preferred embodiment a stepper motor is used to provide additional control. The drive cycle can include higher initial power to initially move the side members followed by a reduction in power to provide good control of the stall condition. This arrangement and the rack and pinion drive arrangement in general, provides better control over time and is more toleration with respect to wear and contamination.

As disclosed in our earlier application, motor 10 is a low torque motor or stepper motor that can be controlled in a manner to vary the stall condition. Typically the centering mechanism will go through a number of cycles to assess the general condition of the centering mechanism without a banknote present to form the basis for setting of the motor parameters to produce the desired stall condition created by the resistance of the banknote when centered. In the example of a stepper motor the power can be initially higher to initiate movement of the side members 4 and 6 and then reduced to a level appropriate for stalling the motor when a banknote is centered.

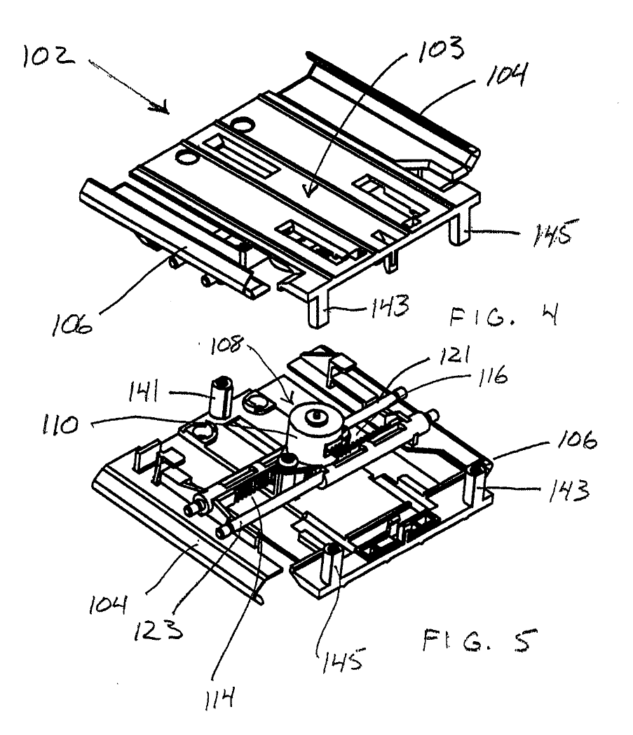

FIG. 3 generally shows a banknote inlet 30, the banknote path 32 through the centering mechanism, the initial drive roller arrangement including the triangular drive 26 and the idler roller 27, and the exiting drive roller 24 and its associated idler roller 25.

The triangular roller includes a number of sensing positions to allow determination of when a banknote is not effectively engaged by the roller. This condition allows for centering of the banknote as the banknote is free to move and be centered by the side engaging members.

The banknote drive 20 effectively allows movement of the banknote to the centering position releasing of the banknote to allow centering and the subsequent re-engagement and movement of the banknote out of the centering mechanism. Other drive arrangements for releasing of the banknote between the side engaging members are possible.

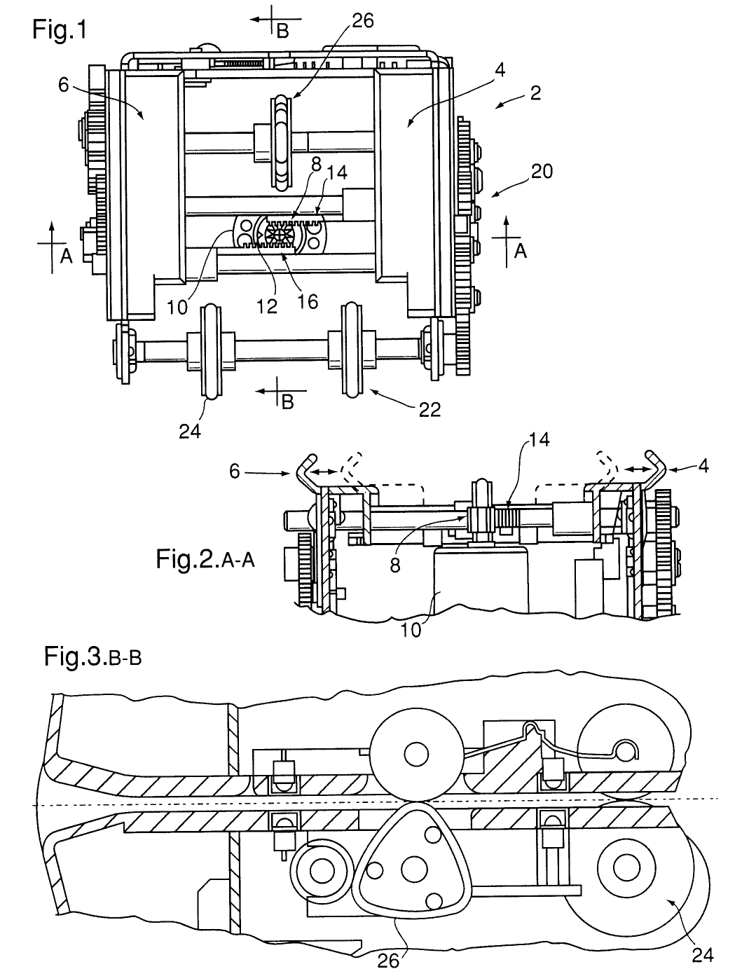

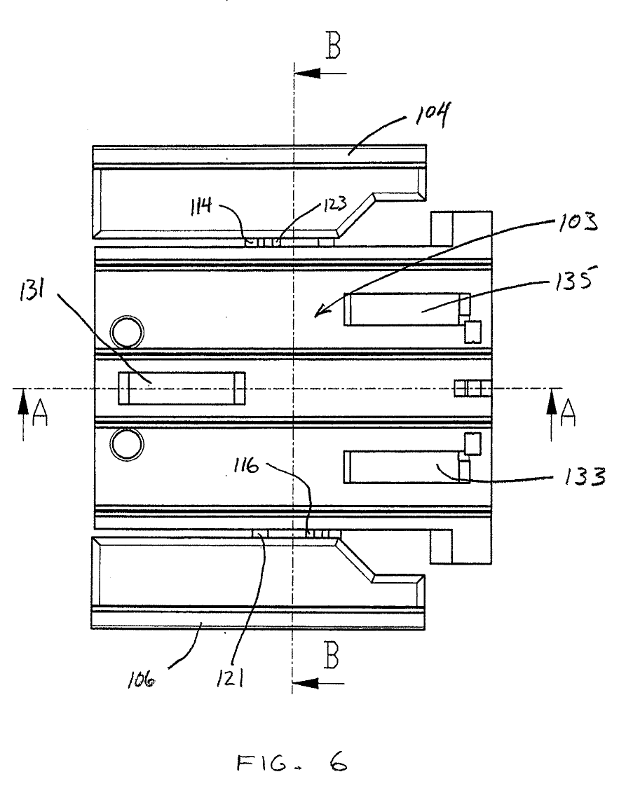

The alternate banknote centering mechanism 102 shown in FIG. 4 is similar to the embodiment of FIGS. 1 through 3, however some of the structural elements have changed. The centering mechanism 102 includes a table support 103 which provides support for the banknote as it is centered within the centering mechanism. Two opposed side members 104 and 106 move towards one another in a controlled manner determined by the centering banknote drive 108. Each of these side members 104 and 106 includes a rack gear 114 and 116 respectively which cooperate with the spur gear 112 of the centering banknote drive 8. The spur gear 112 is driven by the motor 110.

Each of the opposed side members 104 and 106 are slideable along guide shafts 121 and 123 to allow movement of the sliding engaging members towards or away from one another on a control by the centering banknote drive 108.

The embodiments shown in FIGS. 4 through 8 are of the banknote centering mechanism and the table support 103, as well as side members which engage the guide rails 121 and 123 are not shown.

As can be appreciated from the bottom view of FIG. 5, the table support 103 includes three downwardly descending securing studs 141, 143 and 145, which will be secured to the banknote validator. Similarly, the ends of the guide rails 121 and 123 will be secured in the validator. The rack gears 114 and 116 are free to travel intermediate the ends of the guide shafts 121 and 123 in accordance with the drive of the motor drive 108.

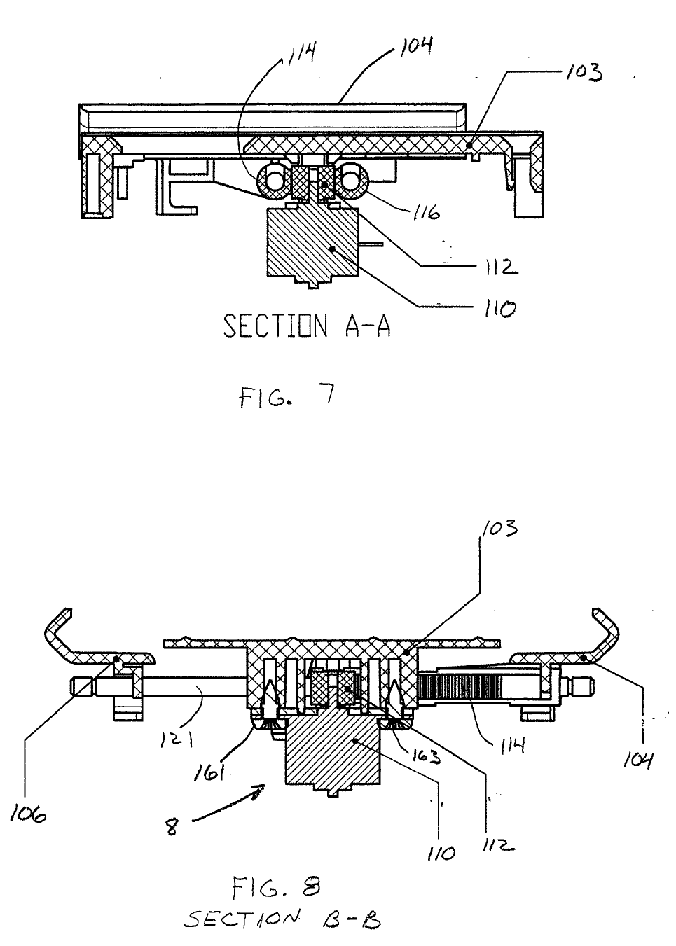

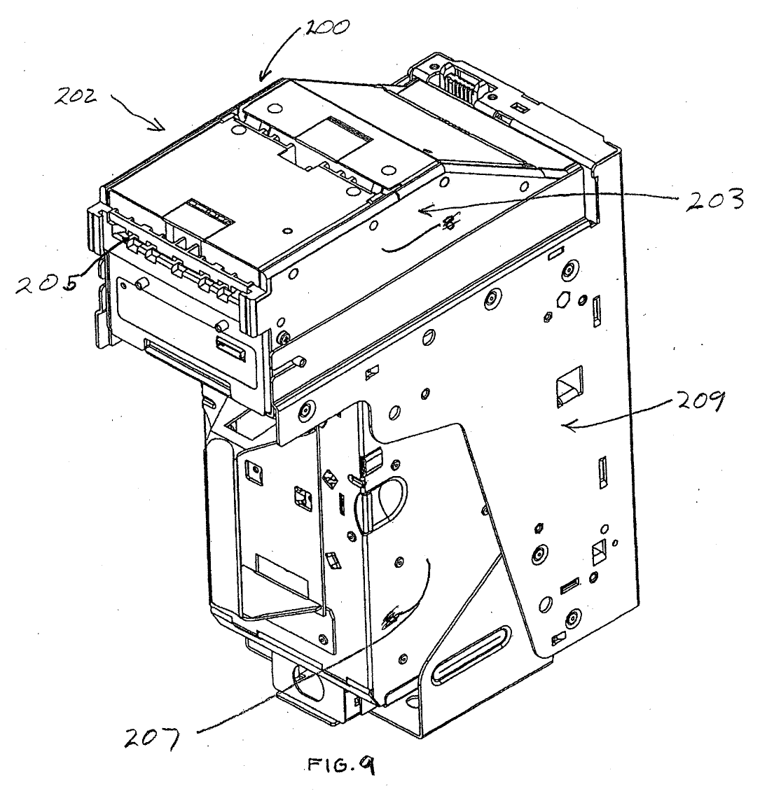

The motor 110 of the drive arrangement 108 includes two outwardly extending flanges that include securing ports for securing the motor drive 8 to the table support 103. This securement is accomplished by these flanges in combination with the screws 161 and 163. As shown in the sectional view of FIG. 8, the motor is held in position centrally beneath the table support 103.

The central table support 103 as shown in FIG. 6 includes ports 131, 133 and 135 for receiving drive members which project slightly through the table support 103. Preferably these drive members are movable relative to the table support 103 from a drive engaging position for driving a banknote through the centering mechanism to a release position allowing the banknote to essentially float on top of the table and be centered by the side engaging members 104 and 106 when moved inwardly towards one another.

FIG. 9 is a perspective view of a banknote validator assembly 200 having a banknote centering mechanism 202 integrated with the banknote validating head 203. This combination is releasably secured within the structural frame 209. Banknotes to be validated are passed through the banknote slot 205 and driven into the banknote centering mechanism 202. The banknote is stopped and the drive mechanism is released to allow the banknote centering mechanism to center the banknote. Basically, the banknote is allowed to float between a stationary bottom member and a top member with the banknote side engaging members being driven towards one another and effectively centering the banknote.

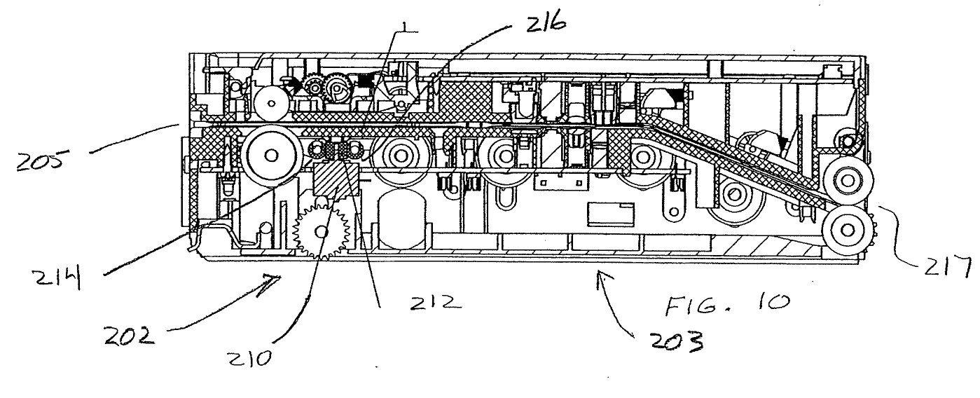

Once the banknote has been centered, the drive of the banknote is resumed and it is processed by the banknote validator 203 as the banknote passes through the validator. If the banknote is accepted, it is passed out of the slot 217 shown in FIG. 10 and provided to the banknote cassette 207 for storage. The banknote cassette 207 is also releasably secured within the structural frame 209.

The sectional view of FIG. 10 shows the relationship of the banknote centering mechanism 202 in the banknote validator 203. A banknote centering mechanism includes a motor drive 210 that drives the spur gear 212. The spur gear is in mesh with the rack gears 214 and 216 that control the position of the side engaging members. Once the banknote has been centered it is passed on to the banknote validator 203 and if accepted, will be discharged through the outlet 217.

It has been found that a banknote centering with the side members driven in a coordinated manner by means of the two rack members in a common spur gear provides excellent control on the banknote centering mechanism and it is more consistent with respect to the operating characteristics thereof over time than the worm drive arrangement of our earlier structure. This rack and pinion drive arrangement is more tolerant with respect to changing operating conditions and in particular due to changing operating conditions over time.

Although various preferred embodiments of the present invention have been described herein in detail, it will be appreciated by those skilled in the art that variations may be made thereto without departing from the spirit of the invention or the scope of the appended claims.

1. In a banknote centering mechanism comprising opposed side members movable towards one another and controlled by a drive mechanism, said drive mechanism comprising a rack and pinion drive arrangement powered by a low torque motor and controlled by a control arrangement that adjusts the power of the motor such that a buckling force produced by a centered banknote and exerted on said opposed side members stalls said low torque motor and stops further inward movement of said side engaging members.

2. In a banknote centering mechanism as claimed in claim 1, wherein said low torque motor is a stepper motor.

3. In a banknote centering mechanism as claimed in claim 2, wherein said control arrangement provides higher power to initially start movement of said side members from an initial start position followed by a reduction in power immediately after static friction necessary to initiate movement of said side engaging members has been overcome.

4. In a banknote centering mechanism wherein each side member includes a rack of said rack and pinion drive arrangement wherein each rack is slidable of a guide rail extending across said banknote centering mechanism.

5. In a banknote centering mechanism as claimed in claim 4 wherein said guide rails are located either side of and in mesh with a pinion gear of said rack and pinion drive arrangement.

6. In a banknote centering mechanism as claimed in claim 5 wherein said pinion gear is directly connected to a drive shaft of said low torque motor.
